(19) United States
(12) Patent Application Publication
(10) Pub. No.: US 2026/0257787 A1
(43) Pub. Date: Sep. 3, 2026

(54) Redundant Blade Pitch Mechanism With Control Links And Geared Coupling And Aircraft Using Same

(71) Applicant: Joby Aero, Inc., Santa Cruz, CA (US)

(72) Inventor: Robert Thodal, Santa Cruz, CA (US)

(21) Appl. No.: 19/405,121

(22) Filed: Dec. 1, 2025

Related U.S. Application Data
(60) Provisional application No. 63/727,200, filed on Dec. 3, 2024.

(51) Int. Cl. B64C 11/32; B64C 29/00

(52) U.S. Cl. CPC B64C 11/32; B64C 29/00

(57) ABSTRACT

A propeller blade pitch control mechanism configured to adjust and control the blade pitch of the blades of a multi-blade propeller simultaneously. The pitch control mechanism may have a pitch plate which is raised or lowered along a liner path along an axial direction using a linear drive, which may be a power screw. The pitch plate is coupled to the blade roots with kinematic links which transfer the linear axial motion of the pitch plate along the propeller spin axis into rotary motion of the propeller blade roots, thereby controlling the pitch of the propeller blades. The propeller blades are also coupled with a ring gear system which can provide redundant drive for a propeller blade. The propeller pitch control mechanism may include one or more springs or gas springs adapted to place the propeller blades in a low drag position in the event of failure of the blade pitch control mechanism.

### CROSS-REFERENCE TO RELATED APPLICATIONS

This application claims the priority benefit of U.S. Provisional Patent Application No. 63/727,200 to Thodal, filed Dec. 3, 2024, which is hereby incorporated by reference in its entirety.

### FIELD OF THE INVENTION

This invention relates to the aviation field, namely a blade pitch control mechanism used on aerial vehicles.

### BRIEF DESCRIPTION OF THE DRAWINGS

FIG. 1 is a sketch of a propulsion system according to some embodiments of the present invention.

FIG. 2A is a vertical take-off and landing aircraft in a take-off configuration according to some embodiments of the present invention.

FIG. 2B is a vertical take-off and landing aircraft in a forward flight configuration according to some embodiments of the present invention.

FIG. 3 is a view of a nacelle and rotor according to some embodiments of the present invention.

FIG. 4A is a view of a rotor assembly with blade pitch mechanism and propeller according to some embodiments of the present invention.

FIG. 4B is a close-in view of a rotor assembly with blade pitch mechanism and propeller according to some embodiments of the present invention.

FIG. 4C is a top view of a rotor assembly with blade pitch mechanism and propeller according to some embodiments of the present invention.

FIG. 5A is a view of a rotor assembly with the top cover of the blade pitch mechanism removed according to some embodiments of the present invention.

FIG. 5B is a view of a rotor assembly with the top cover of the blade pitch mechanism removed according to some embodiments of the present invention.

FIG. 6A is a cross-sectional view of a rotor hub with a blade pitch control mechanism according to some embodiments of the present invention.

FIG. 6B is a cross-sectional view of a rotor hub with a blade pitch control mechanism according to some embodiments of the present invention.

FIG. 7A is a side view of a blade pitch control mechanism with the central housing removed according to some embodiments of the present invention.

FIG. 7B is a view of a blade pitch control mechanism with the central housing removed according to some embodiments of the present invention.

FIG. 8A is a side view of a blade pitch control mechanism with the central housing and the top cover removed according to some embodiments of the present invention.

FIG. 8B is a side view of a blade pitch control mechanism with the central housing and the top cover removed according to some embodiments of the present invention.

FIG. 9A is a side view of a blade pitch control mechanism with the central housing and the top cover removed and the pitch plate in a raised position according to some embodiments of the present invention.

FIG. 9B is a view of a blade pitch control mechanism with the central housing and the top cover removed and the pitch plate in a raised position according to some embodiments of the present invention.

FIG. 10 is a cross-sectional view of a drive for a blade pitch control mechanism according to some embodiments of the present invention.

FIG. 11 is a view of a blade pitch control mechanism with the central housing and the top cover removed and the pitch plate in a raised position according to some embodiments of the present invention.

FIG. 12A is a partial cross-sectional view showing magnets mounted to a ring gear according to some embodiments of the present invention.

FIG. 12B is a cross-sectional view of the position sensor according to some embodiments of the present invention.

### SUMMARY

A propeller blade pitch control mechanism configured to adjust and control the blade pitch of the blades of a multi-blade propeller simultaneously. The pitch control mechanism may have a pitch plate which is raised or lowered along a liner path along an axial direction using a linear drive, which may be a power screw. The pitch plate is coupled to the blade roots with kinematic links which transfer the linear axial motion of the pitch plate along the propeller spin axis into rotary motion of the propeller blade roots, thereby controlling the pitch of the propeller blades. The propeller blades are also coupled with a ring gear system which can provide redundant drive for a propeller blade. The propeller pitch control mechanism may include one or more springs or gas springs adapted to place the propeller blades in a low drag position in the event of failure of the blade pitch control mechanism.

### DETAILED DESCRIPTION

Control of the pitch angle of the blades of a propeller can be very important during the operation of an aircraft. It may be even more important in the case of a vertical take-off and landing (VTOL) aircraft, where there may be significantly more thrust needed during hover operations. Although the requisite thrust distribution for hover operations may be maintained at least in part by moderating the rotational speed of the rotor assemblies, the blade pitch angle may also be part of the operational paradigm. Further, it is likely that the propeller blade pitch angle range used during the hover mode of VTOL operations may be a different range than the propeller blade pitch angle range used during nominal forward flight operations.

In some embodiments of the present invention, a propeller blade pitch angle control mechanism provides a compact, redundant, and reliable device adapted to control and alter the pitch angle of a plurality of propeller blades of an aircraft. In some aspects, the pitch angle of all of the propeller blades of a propeller is altered simultaneously. In some aspects, the pitch angle of all of the propeller blades of a propeller is altered with the use of a single actuation device, which may be a power screw.

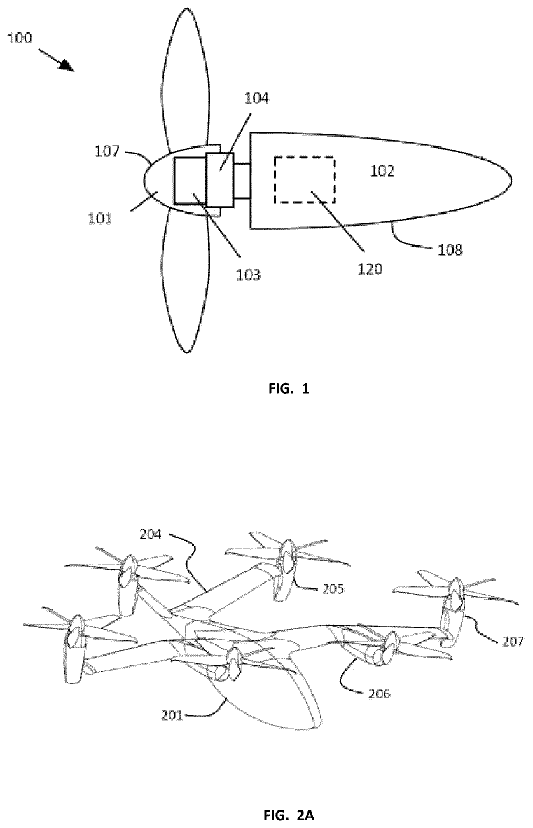

FIG. 1 illustrates a representative aircraft propulsion system 100 which includes: a rotor 101, a nacelle 102, a propeller hub 103, and a drive motor with an external motor rotor 104. The rotor includes a set of blades coupled to the hub 103 and may include a cowling, or spinner 107. The nacelle 102 defines an outer surface 108. The drive mechanism includes a rotary portion 104 rigidly coupled to the hub 103, and a fixed portion coupled to the nacelle. The system 100 can optionally include: a tilt mechanism housed at least partially in the nacelle, a power supply, and any other suitable components. The aircraft propulsion system can be used in conjunction with a rotorcraft. The rotorcraft is preferably a tiltrotor aircraft with a plurality of aircraft propulsion systems (e.g., rotor assemblies, rotor systems, etc.), operable between a forward arrangement and a hover arrangement. However, the rotorcraft can alternatively be a fixed wing aircraft with one or more rotor assemblies, and/or any other suitable rotorcraft or vehicle propelled by rotors. The rotorcraft preferably includes an all-electric powertrain (e.g., battery or hydrogen fuel cell powered electric motors) to drive the one or more rotor assemblies, but can additionally or alternatively include a hybrid powertrain (e.g., a gas-electric hybrid including an internal-combustion generator), an internal-combustion powertrain (e.g., including a gas-turbine engine, a turboprop engine, etc.), and any other suitable powertrain.

The term “rotor” as utilized herein, in relation to the aircraft propulsion system or otherwise, can refer to a rotor, a propeller, and/or any other suitable rotary aerodynamic actuator. While a rotor can refer to a rotary aerodynamic propulsor that makes use of an articulated or semi-rigid hub (e.g., wherein the connection of the blades to the hub can be articulated, flexible, rigid, and/or otherwise connected), and a propeller can refer to a rotary aerodynamic propulsor that makes use of a rigid hub (e.g., wherein the connection of the blades to the hub can be articulated, flexible, rigid, and/or otherwise connected), no such distinction is explicit or implied when used herein, and the usage of “rotor” can refer to either configuration, and any other suitable configuration of articulated or rigid blades, and/or any other suitable configuration of blade connections to a central member or hub. Likewise, the usage of “propeller” can refer to either configuration, and any other suitable configuration of articulated or rigid blades, and/or any other suitable configuration of blade connections to a central member or hub. Accordingly, the tiltrotor aircraft can be referred to as a tilt-propeller aircraft, a tilt-prop aircraft, and/or otherwise suitably referred to or described.

As shown in FIG. 1, the aircraft propulsion system 100 includes: a rotor, a nacelle, and a drive mechanism coupled to the rotor and the nacelle. The rotor includes a set of blades coupled to a hub. The nacelle defines an outer surface and an interior. The drive mechanism includes a rotary portion rigidly coupled to the hub, and a fixed portion coupled to the nacelle. The system 100 can optionally include: a tilt mechanism housed at least partially in the interior of the nacelle, a power supply, and any other suitable components. The rotor functions to rotate in a fluid under the power of the drive mechanism in order to provide thrust (e.g., to an attached aircraft). The rotor includes a set of blades coupled to a hub, and a cowling, or spinner, that at least partially encloses the hub.

The set of blades convert rotational motion to axial thrust, resulting in at least a portion of the fluid having axial momentum (e.g., to provide thrust). The rotor can have any suitable number of blades; the rotor has five blades in an illustrative embodiment, but can alternatively have three blades, four blades, six blades, and any other suitable number of blades. In a specific example, the rotor includes five variable-pitch blades; in alternative examples, the rotor can have any suitable number of blades having variable pitch.

The rotor blades are preferably unconstrained at the blade tips (e.g., by any sort of physical structure), but the rotor can additionally or alternatively include a fairing that encloses the blade tips (e.g., such as the duct of a ducted fan). In such variations, the fairing can function to dampen the acoustic signature components (e.g., acoustic waves) that originate from the blade tips during rotation. However, the rotor blades can additionally or alternatively be constrained or unconstrained in any suitable manner.

The hub functions to mutually couple the set of blades and provide a region at which the rotor couples to the drive mechanism and receives rotary power therefrom. In some aspects, the motor is an outrunner electric motor, and the hub is structurally coupled to a forward surface of the rotor of the electric motor.

The lumen functions to define a volume 120 that retains components of the aircraft propulsion system and/or other aircraft subsystems. Such retained components can include, in variations, at least a portion of a tilt mechanism, all or a portion of the power supply, power delivery subsystems (e.g., electrical power distribution cables, conduits, etc.), mechanical actuators (e.g., for actuating blade pitch or rotor tilt), all or a portion of the drive mechanism, and any other suitable components.

In some aspects, an aerial vehicle may use bladed propellers powered by electric motors to provide thrust during take-off. The propeller/motor units may be referred to as rotor assemblies. In some aspects, the wings of the aerial vehicle may rotate, with the leading edges facing upwards, such that the propellers provide vertical thrust for take-off and landing. In some aspects, the motor driven propeller units on the wings may themselves rotate relative to a fixed wing, such that the propellers provide vertical thrust for take-off and landing. The rotation of the motor driven propeller units may allow for directional change of thrust by rotating both the propeller and the electric motor, thus not requiring any gimbaling, or other method, of torque drive around or through a rotating joint.

In some aspects, aerial vehicles according to embodiments of the present invention take off from the ground with vertical thrust from rotor assemblies that have deployed into a vertical configuration. As the aerial vehicle begins to gain altitude, the rotor assemblies may begin to be tilted forward in order to begin forward acceleration. As the aerial vehicle gains forward speed, airflow over the wings results in lift, such that the rotors become unnecessary for maintaining altitude using vertical thrust. Once the aerial vehicle has reached sufficient forward speed, some or all of the blades used for providing vertical thrust during take-off may be stowed along their nacelles. In some aspects, all rotor assemblies used for vertical take-off and landing are also used during forward flight. The nacelle supporting the rotor assemblies may have recesses such that the blades may nest into the recesses, greatly reducing the drag of the disengaged rotor assemblies.

After take-off, the aerial vehicle will begin a transition to forward flight by articulating the rotors from a vertical thrust orientation to a position which includes a horizontal thrust element. As the aerial vehicle begins to move forward with speed, lift will be generated by the wings, thus requiring less vertical thrust form the rotors. As the rotors are articulated further towards the forward flight, horizontal thrust, configuration, the aerial vehicle gains more speed.

The electric motor/propeller combination being on the deployable side of the articulating joint allows for a rigid mounting of the propeller to the motor, which is maintained even as the propeller is moved through various attitudes relative to the rear nacelle portion. With such a configuration the rotating power from the motor need not be gimbaled or otherwise transferred across a rotating joint. The deployment is of the entire motor driven rotor assembly in some aspects.

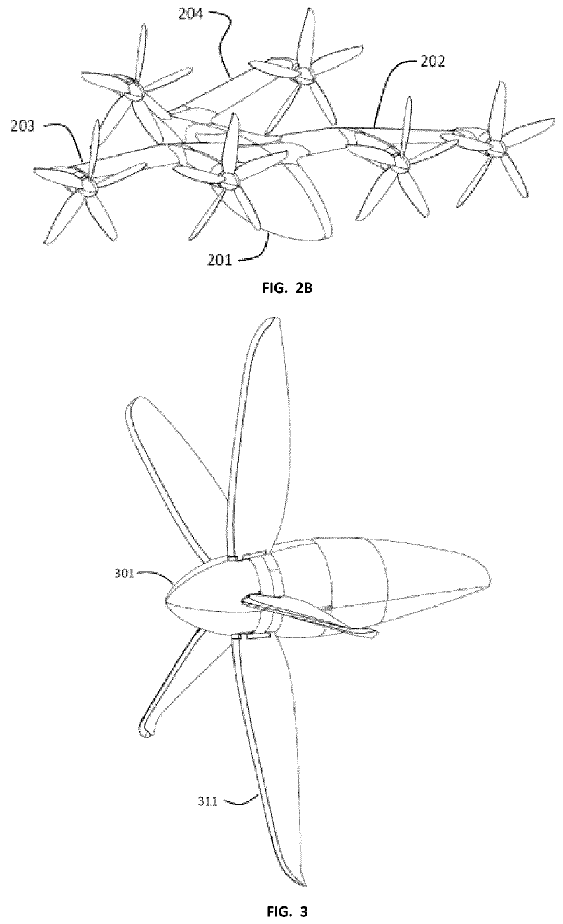

In a first configuration according to some embodiments of the present invention, as seen in a vertical take-off configuration in FIG. 2A and in a forward flight configuration in FIG. 2B, an aerial vehicle 200 uses fixed wings 202, 203, which may be forward swept wings, with rotors of the same or different types adapted for both vertical take-off and landing and for forward flight. The aircraft body 201 supports a left wing 202 and a right wing 203. Motor driven rotor assemblies 206, 207 on the wings include propellers which may stow and nest into the nacelle body. The aircraft body 201 extends rearward is also attached to raised rear stabilizers 204. The rear stabilizers have rear rotor assemblies 205 attached thereto. Although five seats are anticipated, other numbers of passengers and/or total occupants may be accommodated in differing embodiments of the present invention.

In some aspects, all or a portion of the wing mounted rotors may be adapted to be used in a forward flight configuration, while other wing mounted rotors may be adapted to be fully stowed during regular, forward, flight. The aerial vehicle 200 may have two rotors on the right wing 203 and two rotors on the left wing 202. The inboard rotor assemblies on each wing may have wing mounted rotors 206 that are adapted to flip up into a deployed position for vertical take-off and landing, to be moved back towards a stowed position during transition to forward flight, and then to have their blades stowed, and nested, during forward flight. The outboard rotor assembly 207 may pivot from a horizontal to a vertical thrust configuration. It is to be understood that is some flight modes the rotor assemblies may not be tilting in perfect unison, as differential tilt is used for yaw control, for example.

Similarly, each rear stabilizer 204 may be have rotor units mounted to it, both of which are adapted to be used during vertical take-off and landing, and transition, modes. In some aspects, all of the rotor designs are the same, with a subset used with their main blades for forward flight. In some aspects, all of the rotor designs are the same, with all rotors used for forward flight. In some aspects, there may be a different number of rotor units mounted to the rear stabilizer 204.

In some embodiments, the electric motors of the aerial vehicle are powered by rechargeable batteries. The use of multiple batteries driving one or more power busses enhances reliability, in the case of a single battery failure. In some embodiments, the batteries may be spread out along the rotating portion, and there may be one battery for each of the motor/ducted fan assemblies. In some embodiments, the battery or batteries may reside in part or fully within the aircraft body, with power routed out to the motors through the rotational couplings. In some embodiments, the batteries reside within the vehicle body on a rack with adjustable position such that the vehicle balance may be adjusted depending upon the weight of the pilot. In some embodiments, the electric motors of the aerial vehicle are powered by hydrogen powered fuel cells. In some embodiments, the motors of the aerial vehicle are powered by a hybrid power system, which may include a turbogenerator and batteries.

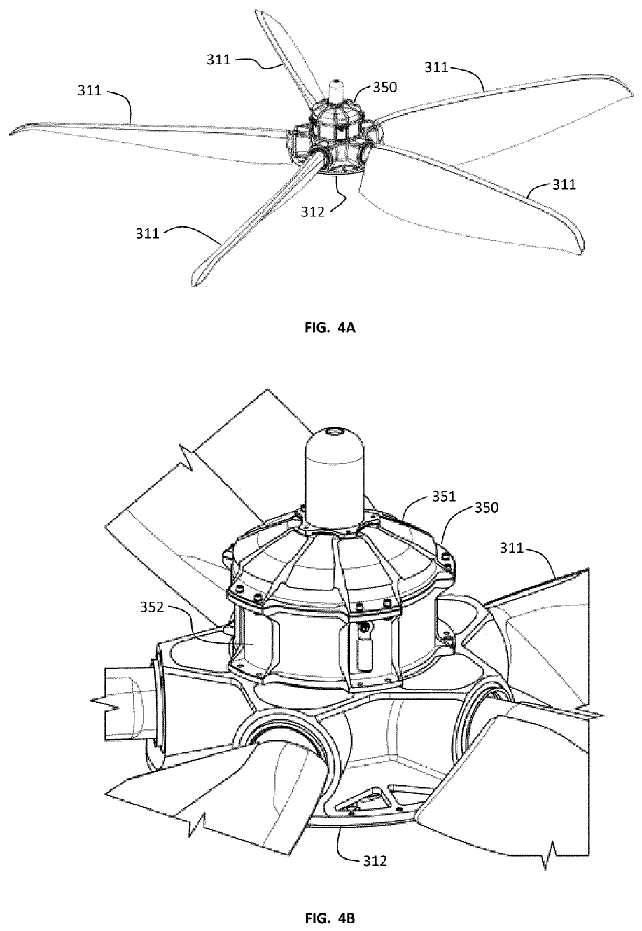

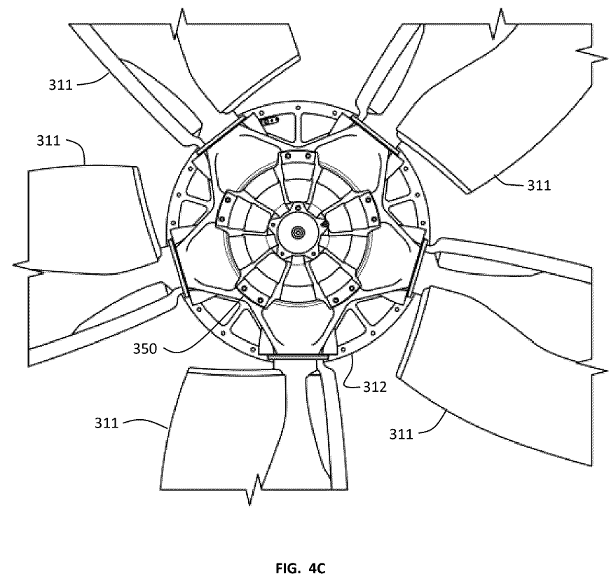

FIG. 3 illustrates a rotor assembly according to some embodiments of the present invention. In this illustrative embodiment, the propeller, with its five blades 311, and spinner 301 are coupled to the rotating structure and reside forward of the nacelle. A deployment mechanism is adapted to pivot the rotor assembly from a forward flight configuration to a vertical take-off and landing configuration.

In some embodiments of the present invention, as seen in FIGS. 4A-C, a propeller blade pitch angle control mechanism 350 is coupled to or within a propeller hub 312. A plurality of propeller blades 311 are rotationally coupled to the propeller hub 312. The propeller blade pitch angle control mechanism 350 has a main housing 352 and top cover 351. The propeller blade pitch angle control mechanism 350 is configured to control the propeller blade pitch angle by the simultaneous pitch rotation of the blades 311.

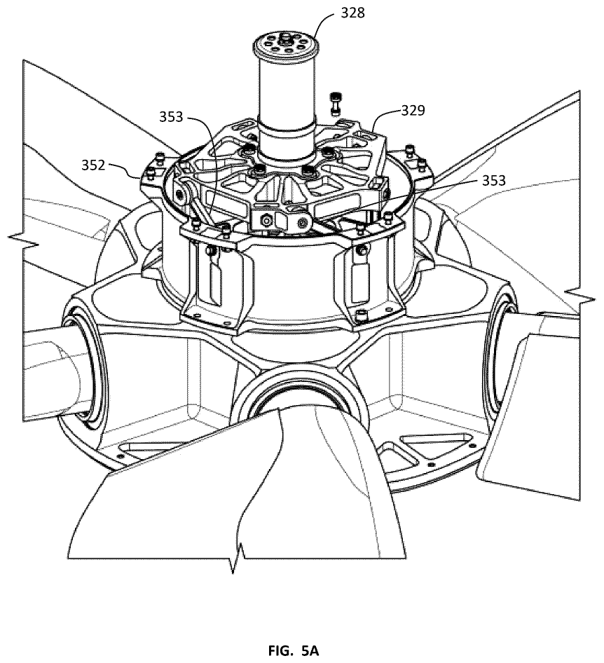

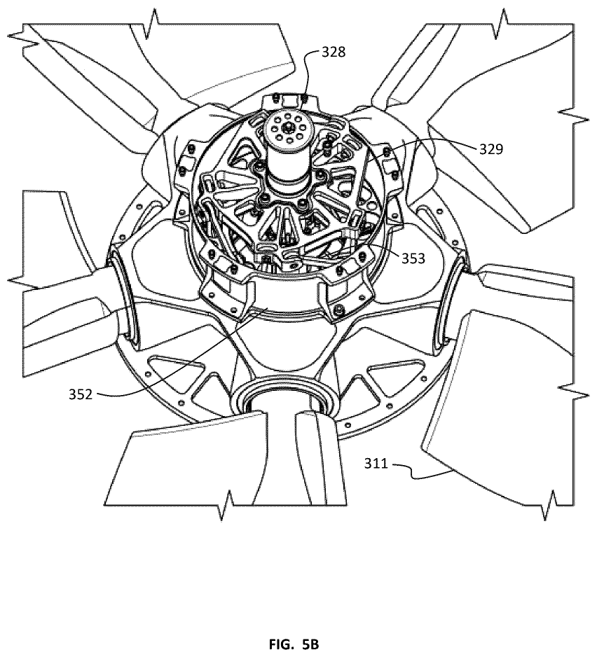

FIGS. 5A-B illustrate the propeller blade pitch angle control mechanism 350 with the top cover 351 removed from the top of the main housing 352. A pitch plate 329 is configured to be raises and lowered in order to effect a change in the pitch angle of the propeller blades 311. The pitch plate 329 is coupled to the main housing 352 with a plurality of cross links 353. The cross links 353 are coupled to an inner surface of the main housing 352 on a first end and coupled to the pitch plate 329 on a second end. The cross links 353 may be coupled to the pitch plate 329 and the main housing 352 using spherical bearings, which may allow for a pivoting link while also accommodative of some out of plane motion. The cross links 353 constrain the rotation of the pitch plate 329, although some limited rotation of the pitch plate 329 relative to the main housing may occur as the pitch plate is raised and lowered due to the shortened and lengthened horizontal distance between the ends of the cross links 353. A gas cylinder 328 is coupled to the top of the pitch plate 329 and is configured to drive the pitch plate downwards should there be a loss of mechanical lock of the pitch plate, or other failure. As will be discussed further below, the propeller blades 311 will be in their highest pitch angle position when the pitch plate is at its lowest elevation.

The gas cylinder is configured to drive down the pitch plate in case of failure so that the blades present the least resistance to forward flight of the aircraft. This allows for the blades to feather through the air as opposed to providing a large drag in the case of extensive failure in the pitch mechanism or of the rotor assembly itself. The aircraft may not be able to maintain attitude control should the blades be in a low pitch position in the case of such a failure.

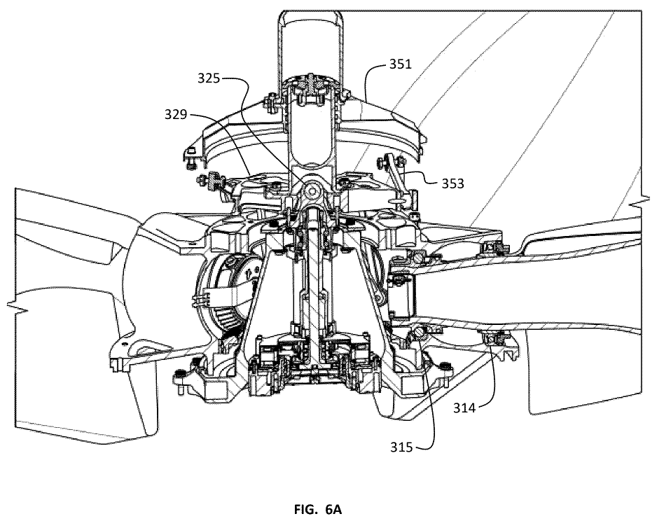

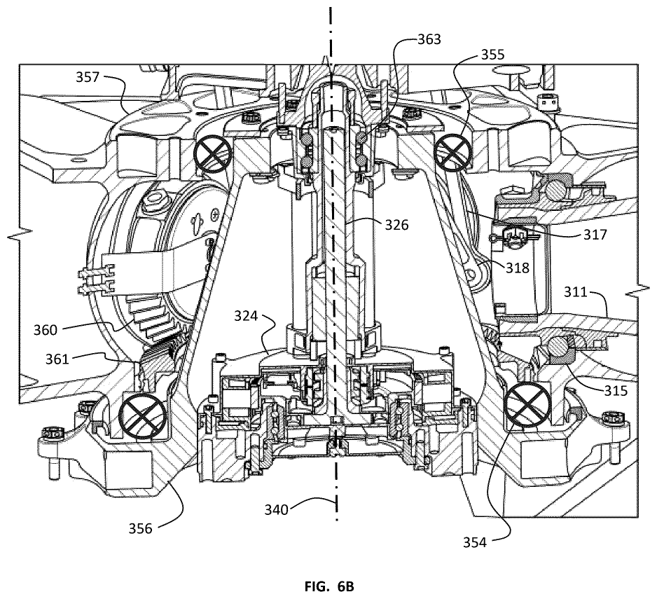

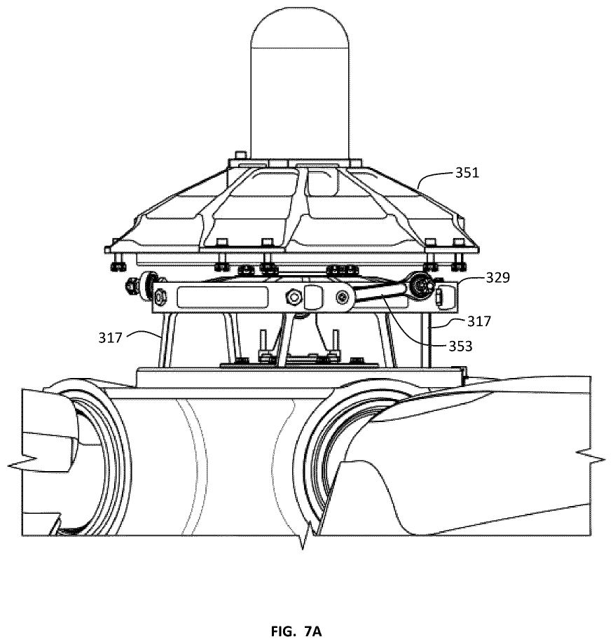

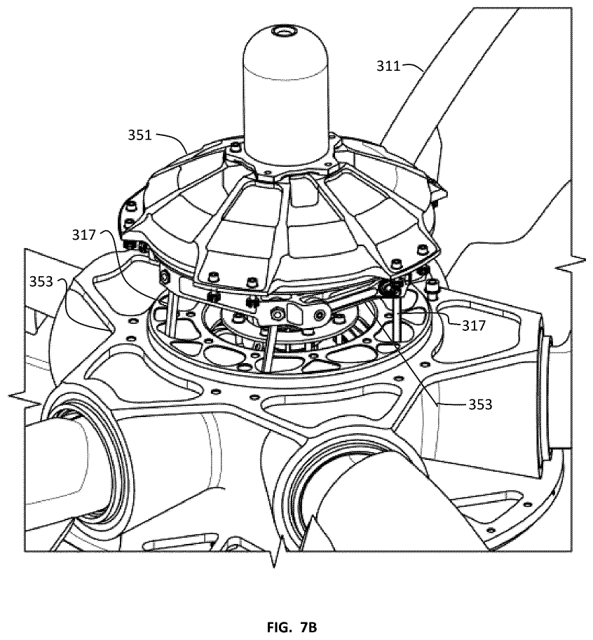

FIGS. 6A-B are cross-sectional views of a rotor assembly with a propeller blade pitch angle control mechanism 350 according to some embodiments of the present invention, with the main housing 352 removed for clarity. A fixed hub 356 is rotationally coupled to the rotor hub 357 with a first hub bearing 354 and a second hub bearing 355. The first hub bearing 354 and the second hub bearing 355 are adapted to provide full structural support for all the loads imposed upon the hub during all flight modes, while providing a fixed axial position and freedom of rotation around the spin axis. In some aspects the fixed hub 356 is coupled to a mounting bracket that itself may be configured to be deployed relative to the aircraft, which may be deployment from a horizontally facing forward flight configuration to a vertically facing hover aircraft, as may be seen with a VTOL aircraft, for example. In some aspects, the fixed hub may be coupled to the aircraft in a non-deployable fashion.

The pitch plate 329 is coupled to the propeller blades 311 with a plurality of pitch control links 317. The pitch control links are coupled to the pitch plate 329 on a first end, and coupled to a control arm 318 at the base of the root of the propeller blade 311 on a second end. The control arm 318 extends out radially from the rotation axis of a propeller blade such that raising and lowering of the first end of a pitch control link 317 results in the rotation of the blade 311, changing the pitch angle of the blade 311. The pitch control links 317 may be coupled to the pitch plate 329 and the control arms 318 using spherical bearings, which may allow for a pivoting link while also accommodative of some out of plane motion. As can be seen in FIG. 6A, with the pitch plate 329 in a lowered elevation the blades 311 are in a state of high pitch angle. In some aspects, the pitch control mechanism can control the blades from a blade pitch angle of 10 degrees to +75 degrees. For clarity of view, the outer housing has been removed from the view of FIG. 6A.

A motor drive unit 324 is fixed relative to the fixed hub 356. The motor drive unit is coupled to a linear drive unit 326. The linear drive unit may contain a power screw which is rotationally driven by a motor in the motor drive unit 324, and this rotational motion becomes linear motion along the extension axis 340 at the drive unit. An upper end 325 of the linear unit is coupled to the pitch plate 329 and is adapted to raise and lower the pitch plate. The base 324 is fixedly coupled to a non-rotating portion of the rotor assembly, which may be coupled the stator housing of the rotor motor. In some aspects, the drive unit comprises recirculating planetary rollers driven by a lead screw. In some aspects, the drive unit may comprise a power screw and drive nut. As the upper end 325 of the linear drive unit is coupled to the rotor hub 357 and the bottom end of the linear drive unit is coupled to the fixed hub 356, bearings 363 are used to provide for that rotary motion. In some aspects, bearings 363 are a duplex pair.

FIGS. 7A-B illustrate the pitch control mechanism in an intermediate elevation with the central housing 352 removed for clarity. The pitch plate 329 is coupled to the blades 311 with the control links 317. The control links 317 enter down into the rotor hub 357 through holes which allow for the slight radial motion of the control links as the pitch plate 327 raises and lowers. The cross link 353 seen in FIGS. 7A-B is coupled to the main housing on a first end and to the pitch plate on a second end. As the main housing is not shown in these two Figures (for illustrative clarity), the first end of the cross-link appears to end in space, whereas in actuality it would be coupled to the main housing.

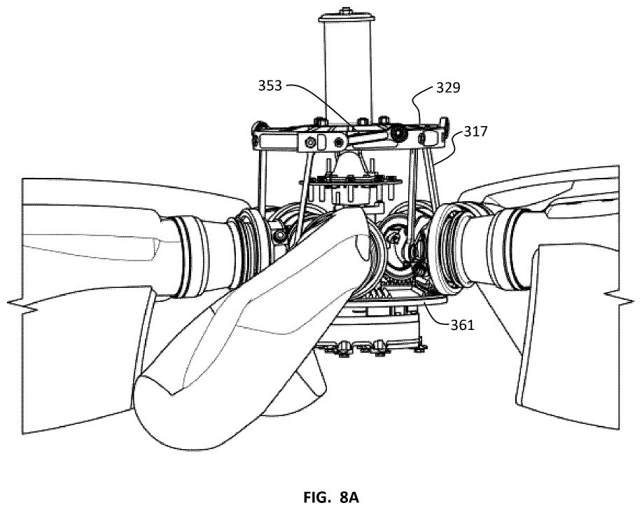

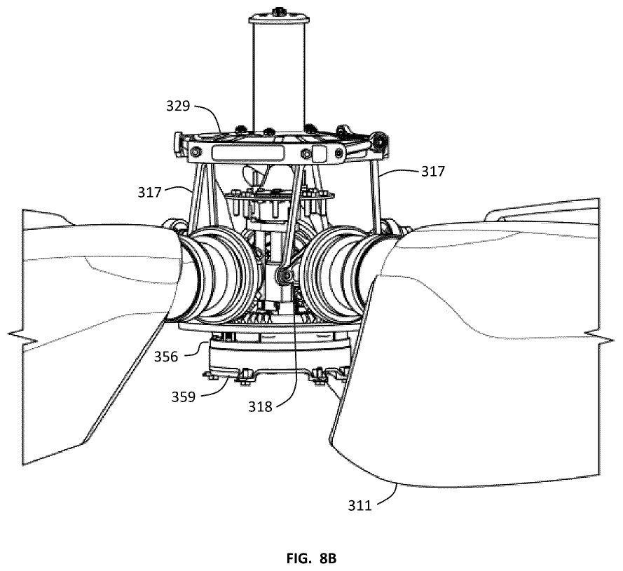

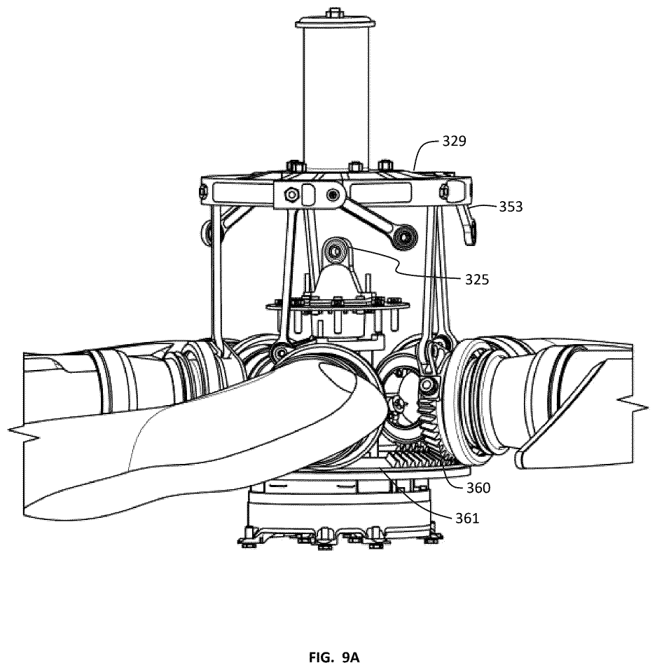

FIGS. 8A-B illustrate the pitch control mechanism in an intermediate elevation with the central housing 352 and the top cover 351 removed for clarity. The pitch control links are coupled to the pitch plate 329 on a first end, and coupled to a control arm 318 at the base of the root of the propeller blade 311 on a second end. The control arm 318 extends out radially from the rotation axis of a propeller blade such that raising and lowering of the first end of a pitch control link 317 results in the rotation of the blade 311, changing the pitch angle of the blade 311. The pitch control links 317 may be coupled to the pitch plate 329 and the control arms 318 using spherical bearings, which may allow for a pivoting link while also accommodative of some out of plane motion. The cross link 353 seen in FIGS. 8A-B is coupled to the main housing on a first end and to the pitch plate on a second end. As the main housing is not shown in these two Figures (for illustrative clarity), the first end of the cross-link appears to end in space, whereas in actuality it would be coupled to the main housing.

FIGS. 8A-B further illustrate a stator bracket 359 which is fixedly coupled to the fixed hub 356. The stator bracket 359 may function as both a bracket and a spacer for coupling the fixed hub 356 to the stator of the electric motor for the motor driven rotor assembly. Although not illustrated in FIGS. 8A-B, the rotor hub 356, as seen in FIG. 6B for example, may be coupled to the rotor of the electric motor for the motor driven rotor assembly. In some aspects, the electric motor may not have its own or additional bearings, and is instead supported by the first hub bearing 354 and the second hub bearing 355.

Although the motor drive unit 324 is configured to translate rotary motion of the motor to linear motion along the drive axis and to thus drive the pitch plate 329 to a desired elevation with its corresponding blade pitch angle, the blades are secondarily coupled together using a ring gear 361. The ring gear 361 is rotationally coupled to the fixed hub 357. In some aspects, the ring gear is rotationally coupled to the fixed hub with a bearing. A mating gear portion 360 is coupled to the base of the root of each blade 311. The mating gear 360 couples each of the blades to each other. If there were to a mechanical failure of one of the pitch control links 317 a blade would still be able to be controlled due to the coupling of the blade to other blades through the mating gear 360.

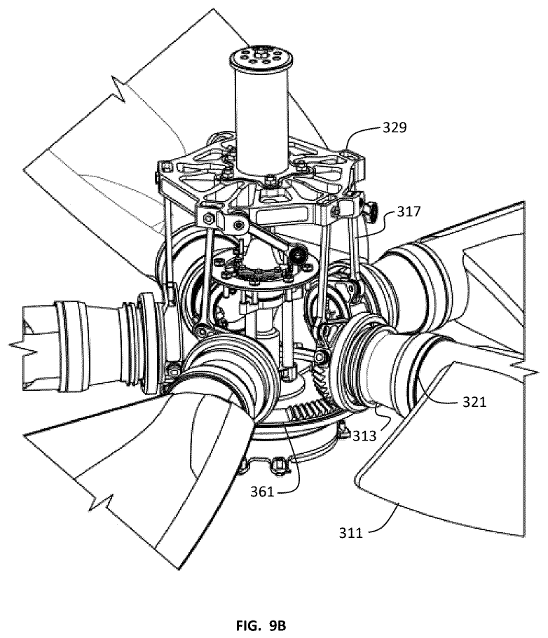

FIGS. 9A-B illustrate the pitch control mechanism in a raised elevation with the central housing 352 and the top cover 351 removed for clarity. This corresponds to the blades having the least amount of blade pitch angle. The pitch control links are coupled to the pitch plate 329 on a first end, and coupled to a control arm 318 at the base of the root of the propeller blade 311 on a second end. The control arm 318 extends out radially from the rotation axis of a propeller blade such that raising and lowering of the first end of a pitch control link 317 results in the rotation of the blade 311, changing the pitch angle of the blade 311. The pitch control links 317 may be coupled to the pitch plate 329 and the control arms 318 using spherical bearings, which may allow for a pivoting link while also accommodative of some out of plane motion. The cross link 353 seen in FIGS. 9A-B is coupled to the main housing on a first end and to the pitch plate on a second end. As the main housing is not shown in these two Figures (for illustrative clarity), the first end of the cross-link appears to end in space, whereas in actuality it would be coupled to the main housing. For illustrative purposes only, the upper end 325 of the linear drive unit is shown not coupled to the pitch plate 329, whereas in practice it would be so coupled.

The ring gear 361 is rotationally coupled to the fixed hub 357. A mating gear portion 360 is coupled to the base of the root of each blade 311. The mating gear 360 couples each of the blades to each other. If there were to a mechanical failure of one of the pitch control links 317 a blade would still be able to be controlled due to the coupling of the blade to other blades through the mating gear 360.

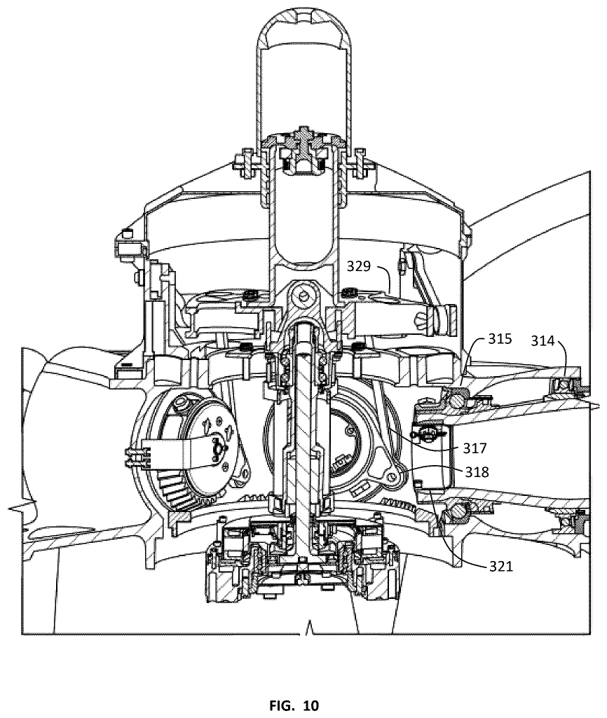

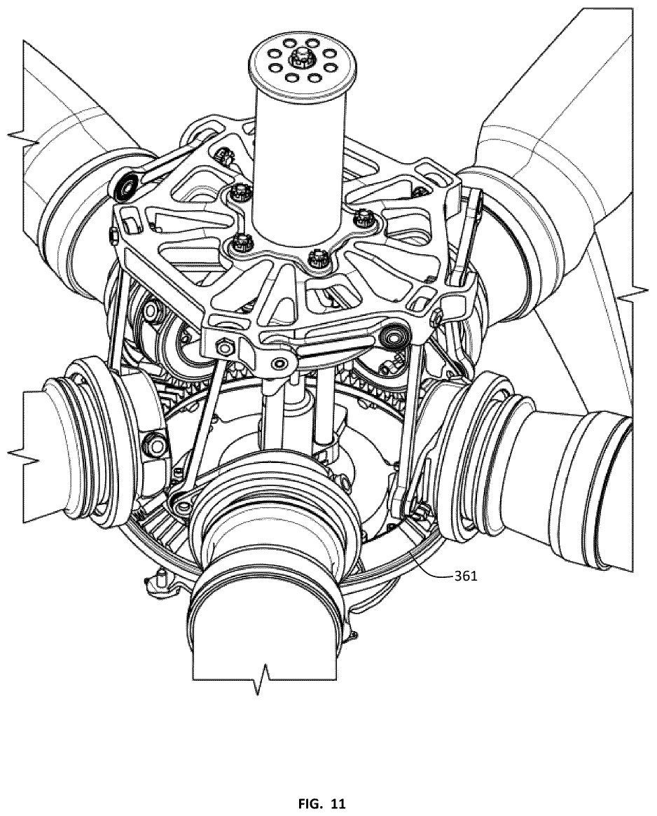

FIG. 10 illustrates the propeller blade pitch angle control mechanism 350 in partial cutaway view. The propeller blade 311 has a blade root 321 which is rotationally coupled to the propeller hub 312. The propeller 311 may be of composite material, such as a carbon fiber composite. The propeller blade root 321 may have a sleeve around its outer periphery. In some aspects, the sleeve may be of metal. In some aspects, propeller blade root may have the inner race of one or both of the root bearings fabricated into or onto the blade root as part of the blade construction. The sleeve 313 may be rotationally coupled to the propeller hub with an outboard root bearing 314 and an inboard root bearing 315. A preload device may be used to provide axial preload to the two bearing system. A control cam 318 may be fixedly coupled to an inboard end on the blade root, and may be coupled to the root sleeve. A pitch control link 317 may be coupled to the pitch plate 329 on a first end, and coupled to the control arm 318 on a second end. Both ends of the pitch control link may be pivotally coupled. In an illustrative example, both ends of the pitch control link are coupled using spherical bearings.

FIG. 11 illustrates the pitch control mechanism in an intermediate elevation with the central housing 352 and the top cover 351 removed for clarity.

In an illustrative embodiment the propeller blades will have 80 degrees of blade pitch control. In some aspects, the propeller blade pitch angle control mechanism 350 will have in the range of 70-90 degrees of blade pitch control. In some aspects, the propeller blade pitch angle control mechanism will have greater than 70 degrees of blade pitch control. In some aspects, the propeller blade pitch angle control mechanism will have greater than 80 degrees of blade pitch control. In an illustrative example, the blades will have pitch control in the range of −10 degrees of pitch to +75 degrees of pitch. In an illustrative example, the blades will have twist along their span, and the pitch will be measure at the ¾ span location.

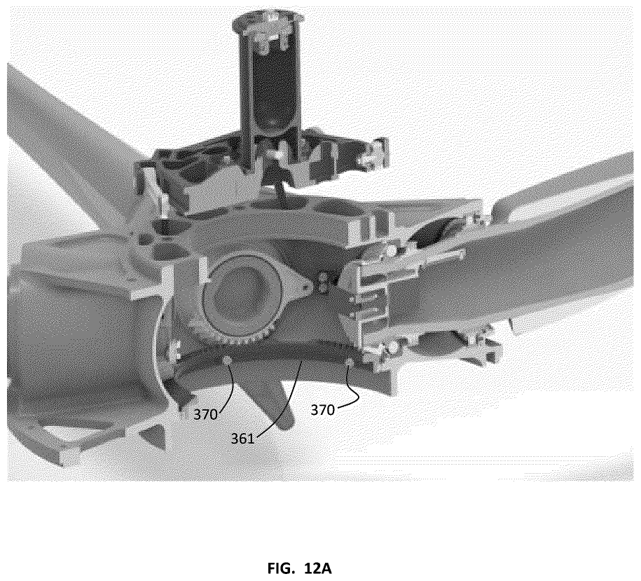

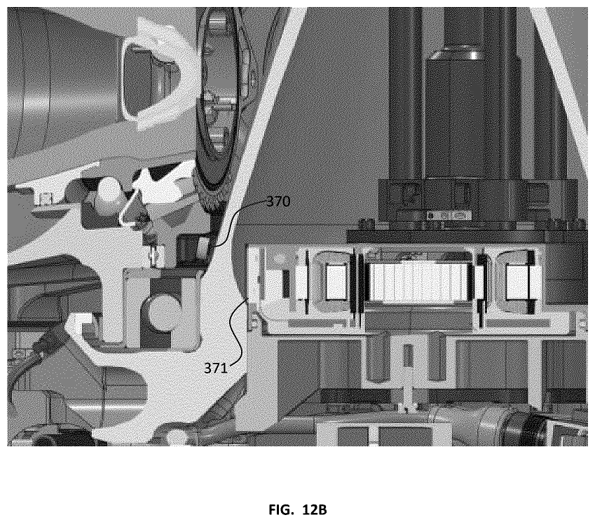

In some embodiments of the present invention, as seen in FIGS. 12A-B, a pitch angle sensor is configured within the hub. A plurality of magnets 370 fixedly coupled to the ring gear 361. A plurality of sensors 371, which may be Hall element transducers, are fixedly coupled to the fixed hub 367. The position of the magnets 370 relative to the sensors 371 will provide information suitable to determine the blade pitch angle of the blades 311. The blade pitch angle is dependent upon the rotary position of the ring gear 361.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A propeller blade pitch control system, said system comprising:
a propeller rotor hub, said propeller rotor hub comprising a spin axis;
a plurality of propeller blades rotationally coupled to said propeller rotor hub, said propeller blades comprising a blade root and a rotation cam at an inner end of said blade root;
a pitch plate, said pitch plate extendably coupled to said propeller rotor hub, said pitch plate configured to be extended closer to or nearer to said propeller hub; and
a plurality of pitch control links, said control links coupled to said pitch plate on a first end, said control links coupled to said rotation cams on a second end;
a ring gear rotationally coupled to said propeller rotor hub, wherein said propeller blades further comprise a mating gear portion engaged with said ring gear.

2. The propeller blade pitch control system of claim 1 further comprising:
an outer housing fixedly coupled to said propeller rotor hub; and
a plurality of cross links, said cross links coupled to said outer housing on a first end, said cross links coupled to said pitch plate on a second end.

3. The propeller blade pitch control system of claim 2 further comprising a fixed hub, wherein said fixed hub is rotationally coupled to said propeller rotor hub.

4. The propeller blade pitch control system of claim 3 wherein said fixed hub is rotationally coupled to said propeller rotor hub with a first hub bearing and a second hub bearing.

5. The propeller blade pitch control system of claim 3 further comprising an extension motor drive unit, said extension motor drive unit configured to drive said pitch plate relative to said propeller rotor hub along said pitch axis, thereby rotating said blade roots of said propeller blades.

6. The propeller blade pitch control system of claim 4 further comprising an extension motor drive unit, said extension motor drive unit configured to drive said pitch plate relative to said propeller rotor hub along said pitch axis, thereby rotating said blade roots of said propeller blades.

7. The propeller blade pitch control system of claim 5 wherein said extension motor drive unit comprises:
an extension motor drive unit base, said extension motor drive unit base fixedly coupled to said fixed hub; and
a linear drive unit, said linear drive unit rotationally coupled to said extension motor drive unit base on a bottom end, said linear drive unit rotationally coupled to said propeller rotor hub on a second end.

8. The propeller blade pitch control system of claim 7 wherein said extension motor drive unit further comprises:
a power screw;
a motor; and
a drive nut, said drive nut coupled to said pitch plate, wherein said motor is configured to rotate said drive screw to drive said pitch plate relative to said propeller rotor hub along said pitch axis, thereby rotating said blade roots of said propeller blades.

9. The propeller blade pitch control system of claim 1 wherein said pitch control links are coupled to said pitch plate and said rotation cams with spherical bearings.

10. The propeller blade pitch control system of claim 2 wherein said pitch control links are coupled to said pitch plate and said rotation cams with spherical bearings.

11. The propeller blade pitch control system of claim 2 wherein said cross links are coupled to said outer housing and said pitch plate with spherical bearings.

12. The propeller blade pitch control system of claim 10 wherein said cross links are coupled to said outer housing and said pitch plate with spherical bearings.

13. The propeller blade pitch control system of claim 8 wherein said drive screw is rotationally coupled to said pitch plate with a bearing.

14. The propeller blade pitch control system of claim 8 wherein said pitch control links are coupled to said pitch plate and said rotation cams with spherical bearings.

15. The propeller blade pitch control system of claim 14 wherein said cross links are coupled to said outer housing and said pitch plate with spherical bearings.

16. The propeller blade pitch control system of claim 2 further comprising a gas cylinder, said gas cylinder coupled to said pitch plate, said gas cylinder configured to drive said pitch plate downward in the event of loss of mechanical lock of said pitch plate.

17. The propeller blade pitch control system of claim 15 further comprising a gas cylinder, said gas cylinder coupled to said pitch plate, said gas cylinder configured to drive said pitch plate downward in the event of loss of mechanical lock of said pitch plate.

18. The propeller blade pitch control system of claim 1 further comprising a blade pitch angle sensor system, said blade pitch angle sensor system comprising:
a plurality of magnets coupled to said ring gear; and
a plurality of sensors coupled to said fixed hub.

19. The propeller blade pitch control system of claim 17 further comprising a blade pitch angle sensor system, said blade pitch angle sensor system comprising:
a plurality of magnets coupled to said ring gear; and
a plurality of sensors coupled to said fixed hub.
